(19) United States
(12) Patent Application Publication
(10) Pub. No.: US 2009/0242711 A1
(43) Pub. Date: Oct. 1, 2009

(54) Wire attachment device for vehicle

(76) Inventor: Fang Lin Yang, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/079,147

(22) Filed: Mar. 25, 2008

(51) Int. Cl. F16L 3/08

(52) U.S. Cl. 248/74.3

(57) ABSTRACT

A wire attachment device for a vehicle includes a strap having a flap extended at one side of an intermediate partition for forming a space between the intermediate partition and the flap, and a panel extended at the other side for forming a compartment between the intermediate partition and the panel, and one or more wires or cables engageable into either of the space or the compartment of the strap and shielded by the strap for preventing the wires from being exposed and from spoiling the outer appearance of the vehicle and for preventing the wires from being hooked by the other objects, and a light device has a carrier for stably anchoring and supporting the strap.

### BACKGROUND OF THE INVENTION

1. Field of the Invention

The present invention relates to a wire attachment device, and more particularly to a wire attachment device for attaching to various portions of a vehicle for receiving and shielding one or more wires or cables and for preventing the wires or cables from being exposed.

2. Description of the Prior Art

Typical vehicles or automobiles may comprise one or more rain shields attached to the side portions or the roof trough of the vehicles or automobiles for shielding and for preventing the entry of rain in cars.

For example, U.S. Pat. No. 4,426,111 to Smith discloses one of the typical automobile rain shields for attaching to the side portions of the vehicles or automobiles. However, when side signaling lights are attached to the typical automobile rain shields, there is no place to accommodate the electric wires or cables for the side signaling lights, and the electric wires or cables will be exposed and will spoil the outer appearance of the vehicles or automobiles.

U.S. Pat. No. 5,311,417 to Heh, and U.S. Pat. No. 6,648,492 to Shih disclose two typical illuminative devices for attaching to automobiles or vehicles and comprising electric wires or cables for coupling the light members together.

However, similarly, the electric wires or cables will also be exposed and will spoil the outer appearance of the vehicles or automobiles and will also be easily hooked by the other objects. The vehicles or automobiles have no wire attachment devices provided for receiving and shielding the wires or cables and for preventing the wires or cables from being exposed.

The present invention has arisen to mitigate and/or obviate the afore-described disadvantages of the conventional wire receiving or shielding or attachment devices.

### SUMMARY OF THE INVENTION

The primary objective of the present invention is to provide a wire attachment device for attaching to various portions of a vehicle for receiving and shielding one or more wires or cables and for preventing the wires or cables from being exposed.

The other objective of the present invention is to provide a wire attachment device including a signaling light device having a carrier for stably anchoring and supporting the longitudinal and flexible strap.

In accordance with one aspect of the invention, there is provided a wire attachment device for a vehicle comprising a light device including a carrier, a strap attached to the carrier and including an intermediate partition, and including a flap provided at one side and spaced from the intermediate partition for forming a space between the intermediate partition and the flap, and including a panel provided at another side and spaced from the intermediate partition for forming a compartment between the intermediate partition and the panel, and a wire coupled to the light device and received and engaged in either the space or the compartment of the strap and shielded by the strap for preventing the wire from being exposed.

The light device includes at least one light member disposed in the carrier and electrically coupled to the wire for electrically coupling the light member to the electric power source.

The light device includes a flange extended from the carrier for forming a shoulder between the carrier and the flange and for engaging with the strap and for stably anchoring and supporting the strap to the carrier of the light device. For example, the flange may be extended rearwardly from a rear portion and/or a bottom portion of the carrier.

The intermediate partition of the strap includes a straight and planar structure. The strap may include a rounded surface formed on the flap, and the strap may also include a rounded surface formed on the panel for allowing the wire to be easily engaged into either the space or the compartment of the strap, or for facilitating the engagement of the wire into either the space or the compartment of the strap.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a wire attachment device in accordance with the present invention for attaching to a vehicle and for receiving and shielding one or more wires or cables;

FIG. 2 is an enlarged partial perspective view of the wire attachment device;

FIG. 3 is a partial exploded view of the wire attachment device;

FIG. 4 is an enlarged perspective view of the wire attachment device;

FIG. 5 is a partial cross sectional view of the wire attachment device taken along lines 5-5 of FIG. 2;

FIG. 6 is a partial cross sectional view similar to FIG. 5 illustrating the other arrangement of the wire attachment device;

FIG. 7 is a further partial cross sectional view similar to FIGS. 5 and 6 illustrating the further arrangement of the wire attachment device;

FIG. 8 is a partial perspective view similar to FIG. 1 illustrating the other application of the wire attachment device;

FIG. 9 is an enlarged partial perspective view of the wire attachment device as shown in FIG. 8;

FIG. 10 is a partial perspective view similar to FIGS. 1 and 8 illustrating the further application of the wire attachment device;

FIG. 11 is an enlarged partial perspective view of the wire attachment device as shown in FIG. 10;

FIG. 12 is an enlarged perspective view similar to FIG. 4 showing the still further application of the wire attachment device;

FIG. 13 is an enlarged perspective view similar to FIGS. 4 and 12 illustrating the still further application of the wire attachment device;

FIG. 14 is an enlarged perspective view similar to FIGS. 4 and 12-13 illustrating the still further application of the wire attachment device; and

FIG. 15 is an enlarged perspective view similar to FIGS. 4 and 12-14 illustrating the still further application of the wire attachment device.

### DETAILED DESCRIPTION OF THE PREFERRED EMBODIMENT

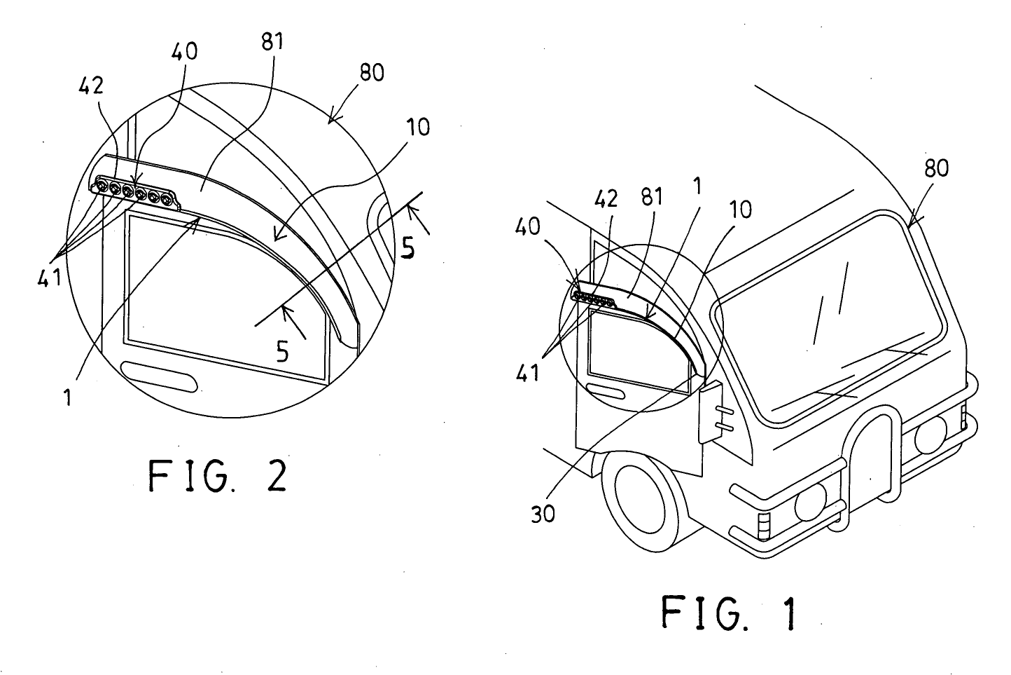

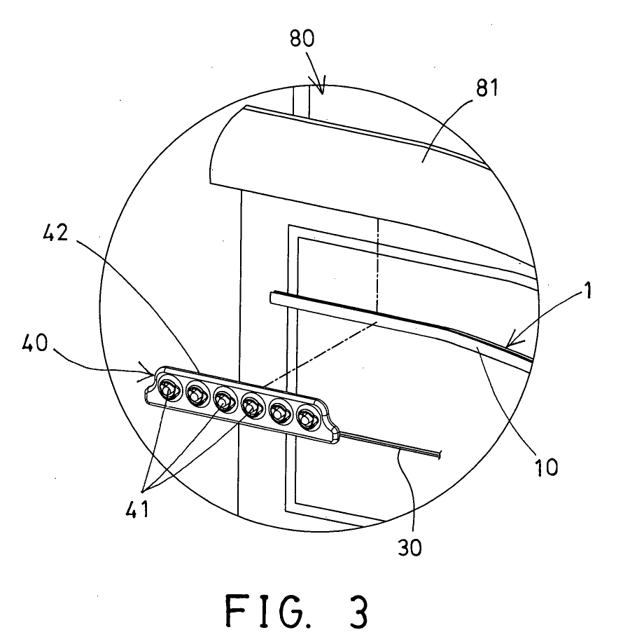

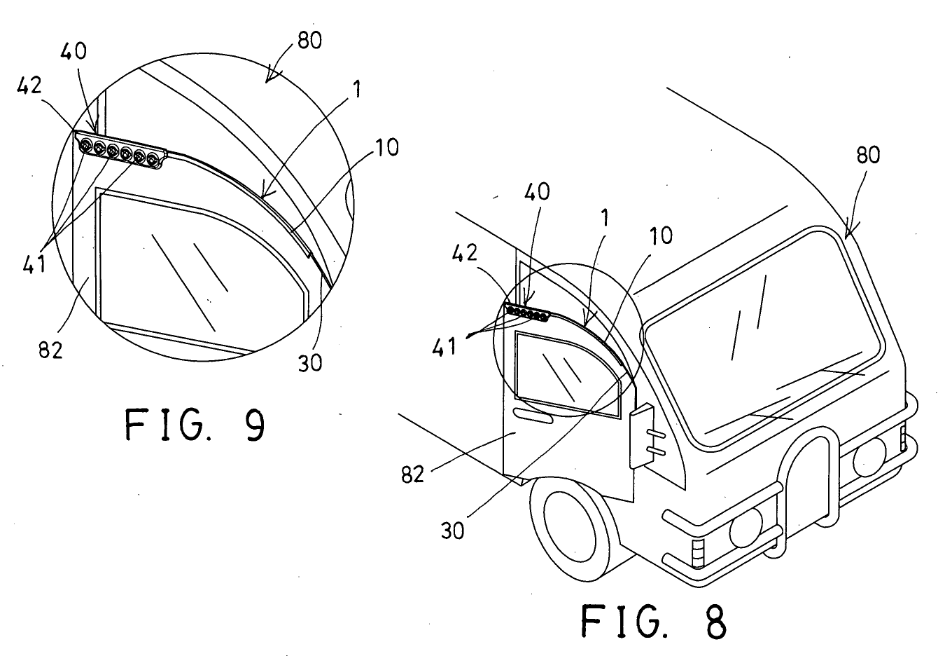

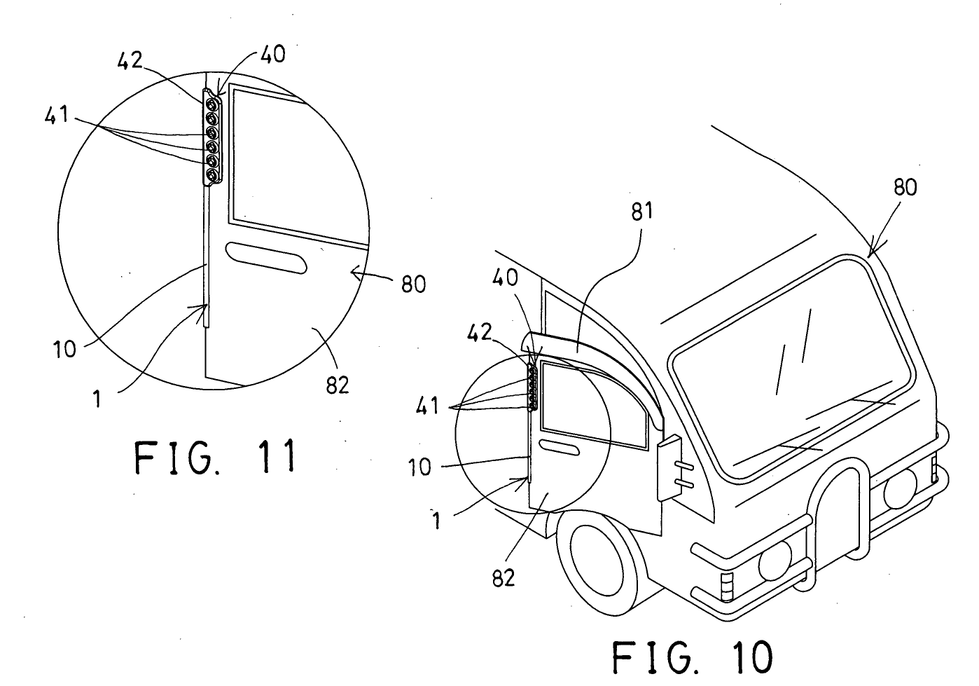

Referring to the drawings, and initially to FIGS. 1-5, a wire attachment device 1 in accordance with the present invention is provided for attaching to a vehicle 80, and preferably for attaching to various flange members or edge portions 81, 82, 83 of the vehicle 80, such as the rain shields 81 (FIGS. 1-3, 5-7), the windows or doors 82 (FIGS. 8-11), or the engine housing 83 (not shown), the trunk covers (not shown), the bumpers (not shown), the rear partitions (not shown) etc., and for receiving and shielding one or more wires or cables 30 and for preventing the wires or cables 30 from being exposed. The various flange members or edge portions 81, 82, 83 of the vehicle 80 are typical and will not be described in further details.

The wire attachment device 1 comprises one or more side signaling light devices 40 attached to the typical automobile rain shields 81 (FIGS. 1-3), or attached to the windows or doors 82 (FIGS. 8-11), or attached to the other portions of the vehicle 80, and including one or more light members 41 disposed in a carrier 42 and electrically coupled to the wires or cables 30 that may electrically couple the signaling light devices 40 to the electric reservoir (not shown) of the vehicle 80 for energizing the light members 41 of the signaling light devices 40. The wire attachment device 1 is thus provided for receiving and shielding the wires or cables 30 and for preventing the wires or cables 30 from being exposed.

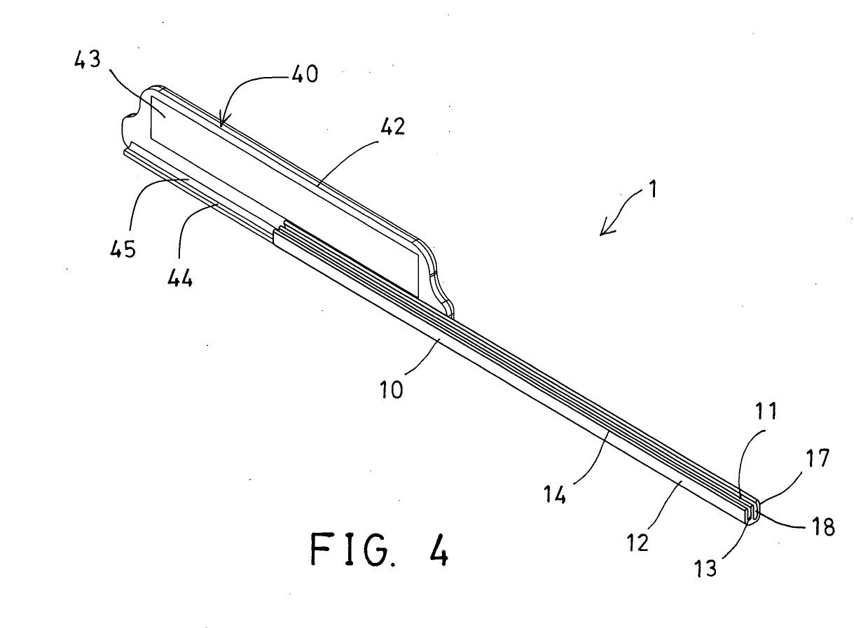

As shown in FIGS. 4-7 and 12-15, the carrier 42 of the signaling light device 40 includes a rear portion or surface 43, a flange 44 extended rearwardly from the rear portion or surface 43 of the carrier 42, such as extended rearwardly from the bottom portion of the carrier 42 for forming or defining a shoulder 45 between the rear portion or surface 43 of the carrier 42 and the flange 44 and for receiving or engaging with a longitudinal and flexible strap 10 and for stably anchoring and supporting the longitudinal and flexible strap 10 to the carrier 42 of the signaling light device 40.

As shown in FIGS. 4-6 and 12-15, the longitudinal and flexible strap 10 of the wire attachment device 1 may be made of such as rubber, plastic or other synthetic materials, and formed or manufactured by such as molding or mold-injection processes, and the strap 10 includes a substantially straight or planar intermediate partition 11, a flap 12 provided or extended beside or at one side portion 60 of the intermediate partition 11 and spaced from the intermediate partition 11 for forming a space 13 between the intermediate partition 11 and the flap 12 and for receiving or engaging with the rain shields 81 (FIG. 6), the windows or doors 82 (FIGS. 8-11), or the engine housing or the other portions of the vehicle 80.

It is to be noted that the flexible strap 10 is made of such as rubber, plastic or other synthetic materials and may resiliently clamp onto the various portions 81, 82, 83 of the vehicle 80, and may further solidly secured onto the vehicle 80 with such as adhesives or weldings, latches or fasteners (not shown), or the like. It is preferable that the strap 10 includes an end or bead 14 provided or formed on or at the outer or free end portion of the flap 12 and having a rounded outer or inner surface 15 for allowing the various portions 81, 82, 83 of the vehicle 80 to be easily engaged into the space 13 of the strap 10, and the flap 12 preferably includes a curved structure for further increasing the resilience of and the flap 12.

The strap 10 further includes a panel 17 also provided or extended beside or at the other side portion 70 of the intermediate partition 11, and opposite to the flap 12, and also spaced from the intermediate partition 11 for forming a compartment 18 between the intermediate partition 11 and the panel 17 and for receiving or shielding or engaging with the wires or cables 30 (FIG. 6), and/or for receiving or engaging with the rain shields 81 (FIGS. 1-3, 5, 7), the windows or doors 82 or the engine housing or the other portions of the vehicle 80, and thus for preventing the wires or cables 30 from being exposed and for preventing the wires or cables 30 from spoiling the outer appearance of the vehicle 80. It is also preferable that the strap 10 includes an end or bead 19 provided or formed on or at the outer or free end portion of the panel 17.

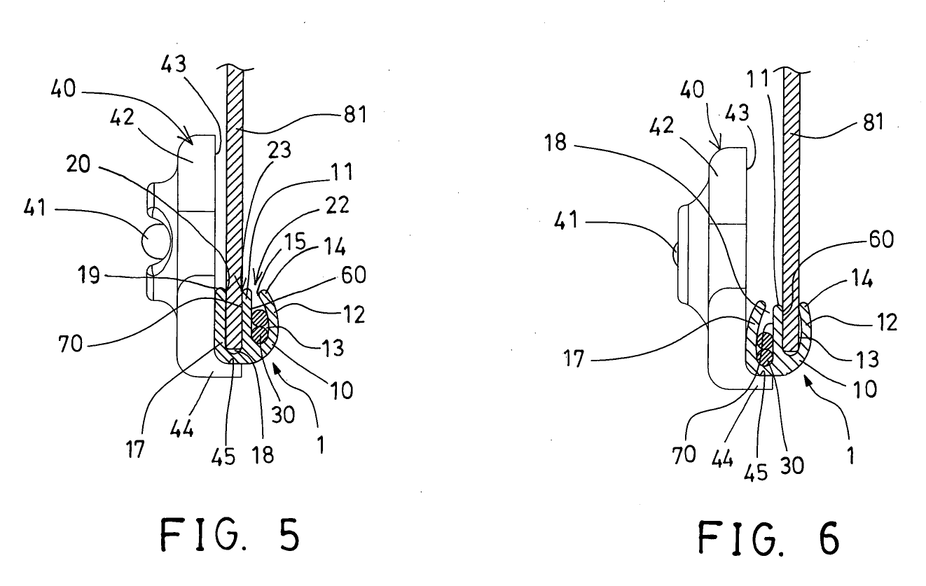

It is further preferable that the strap 10 also includes a rounded outer or inner surface 20 for allowing the wires or cables 30 and/or the various portions 81, 82, 83 of the vehicle 80 to be easily engaged into the compartment 18 of the strap 10, and the panel 17 also preferably includes a curved structure for further increasing the resilience of and the panel 17. It is further preferable, but not necessarily that the space 13 of the strap 10 includes an opening or open end 22, and the compartment 18 of the strap 10 also includes an opening or open end 23 opened or faced toward the same side or end or direction as the open end 22 of the space 13 of the strap 10 (FIGS. 5, 6).

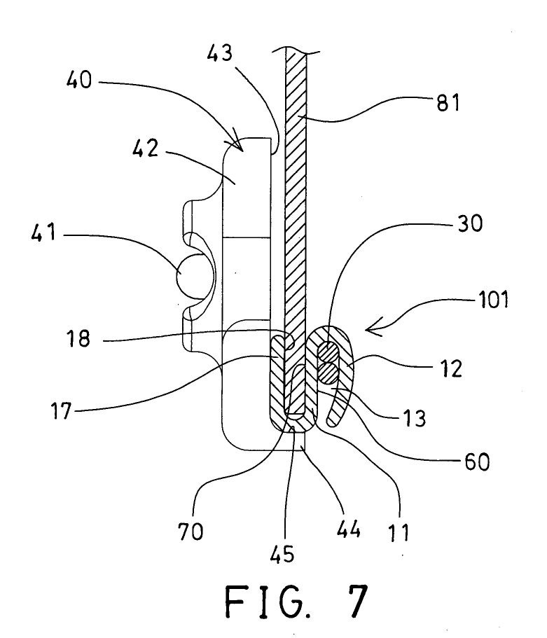

Alternatively, as shown in FIG. 7, the strap 101 may also include an intermediate partition 11, a flap 12 provided or extended beside or at one side portion 60 of the intermediate partition 11 and spaced from the intermediate partition 11 for forming a space 13 between the intermediate partition 11 and the flap 12 and for receiving or engaging with the wires or cables 30 or the other portions of the vehicle 80, and the panel 17 is provided or extended beside or at the other side portion 70 of the intermediate partition 11, and opposite to the flap 12, and also spaced from the intermediate partition 11 for forming a compartment 18 between the intermediate partition 11 and the panel 24 and for receiving or engaging with and shielding the rain shields 81, the windows or doors or the engine housing or the other portions of the vehicle 80, or the wires or cables 30, and having an opening or open end opened or faced toward the different or opposite side or end or direction as the open end 22 of the space 13 of the strap 10.

In operation, the longitudinal and flexible strap 10 of the wire attachment device 1 may be attached onto the various portions 81, 82, 83 of the vehicle 80, such as the rain shields 81 (FIGS. 1-3), the windows or doors 82 (FIGS. 8-11), or the engine housing or the other portions of the vehicle 80 by engaging the flange members or edge portions 81, 82, 83 of the vehicle 80 into the space 13 or the compartment 18 of the strap 10, and the wires or cables 30 may then be received and engaged into the compartment 18 or the space 13 of the strap 10 and shielded by the strap 10 for preventing the wires or cables 30 from being exposed and thus for preventing the wires or cables 30 from spoiling the outer appearance of the vehicle 80.

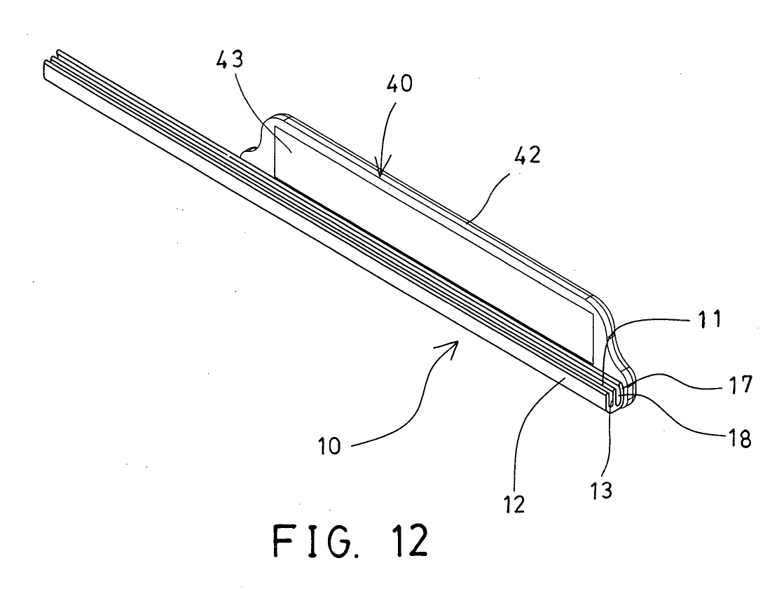

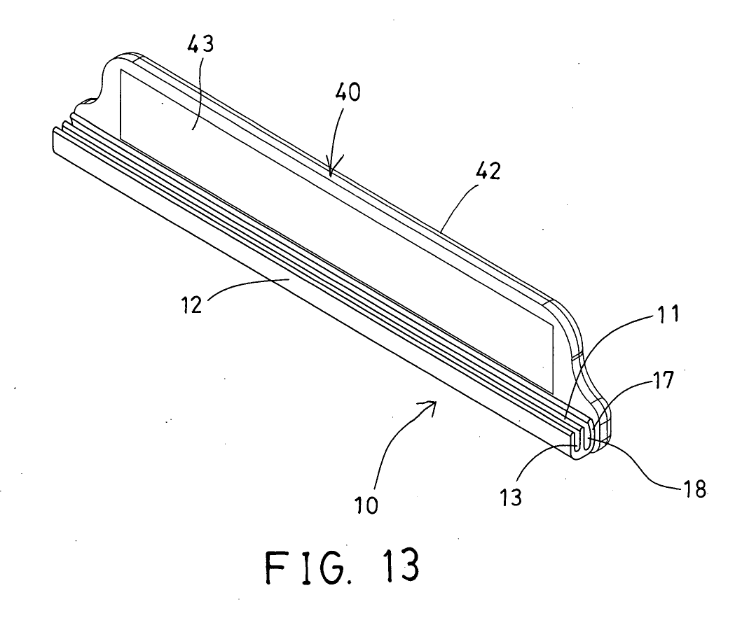

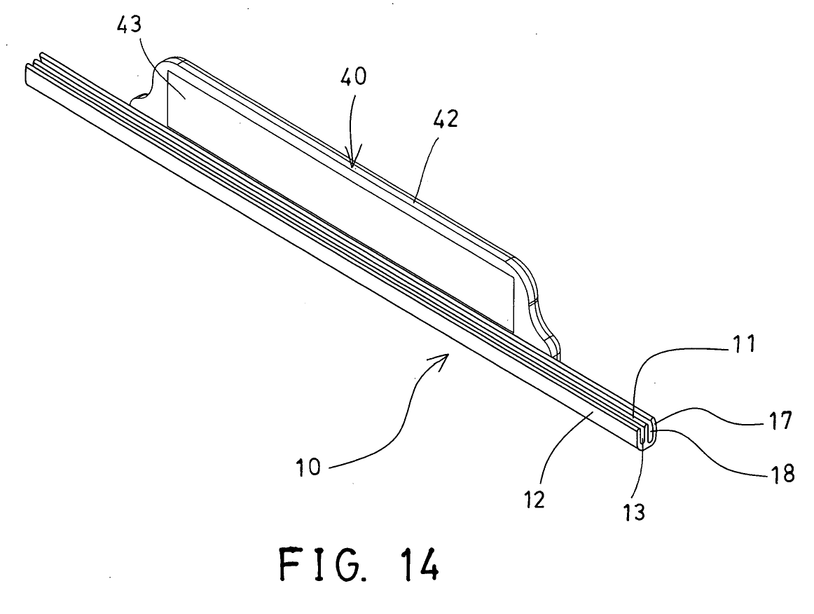

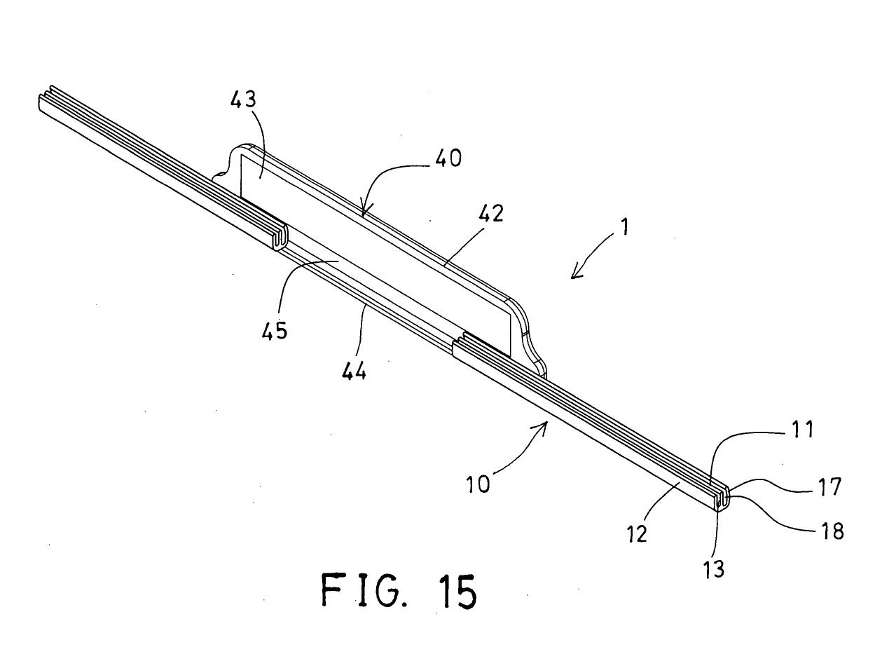

As shown in FIG. 12, alternatively, the strap 10 may be extended out of the other side of the carrier 42 of the signaling light device 40, or do not extended out of the side portions of the carrier 42 of the signaling light device 40 (FIG. 13), or extended out of both sides of the carrier 42 of the signaling light device 40 (FIG. 14), or the strap 10 may include two strap segments extended out of both sides of the carrier 42 of the signaling light device 40 (FIG. 15). It is to be noted that the extension or the provision of the flange 44 and/or the shoulder 45 in the carrier 42 may be used to stably receive or engage with the longitudinal and flexible strap 10 and to stably anchor and support the longitudinal and flexible strap 10 to the carrier 42 of the signaling light device 40.

Accordingly, the wire attachment device in accordance with the present invention may be provided for attaching to various portions of a vehicle for receiving and shielding one or more wires or cables and for preventing the wires or cables from being exposed, and includes a signaling light device having a carrier for stably anchoring and supporting the longitudinal and flexible strap.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wire attachment device for a vehicle comprising:
a light device including a carrier,
a strap attached to said carrier and including an intermediate partition, and including a flap provided at one side and spaced from said intermediate partition for forming a space between said intermediate partition and said flap, and including a panel provided at another side and spaced from said intermediate partition for forming a compartment between said intermediate partition and said panel, and
a wire coupled to said light device and received and engaged in either said space or said compartment of said strap and shielded by said strap for preventing said wire from being exposed.

2. The wire attachment device as claimed in claim 1, wherein said light device includes at least one light member disposed in said carrier and electrically coupled to said wire.

3. The wire attachment device as claimed in claim 1, wherein said light device includes a flange extended from said carrier for forming a shoulder between said carrier and said flange and for engaging with said strap.

4. The wire attachment device as claimed in claim 3, wherein said flange is extended rearwardly from a rear portion of said carrier.

5. The wire attachment device as claimed in claim 1, wherein said intermediate partition of said strap includes a straight and planar structure.

6. The wire attachment device as claimed in claim 1, wherein said strap includes a rounded surface formed on said flap for facilitating an engagement of said wire into said space of said strap.

7. The wire attachment device as claimed in claim 5, wherein said strap includes a rounded surface formed on said panel for facilitating an engagement of said wire into said compartment of said strap.
